(19) United States
(12) Patent Application Publication
(10) Pub. No.: US 2020/0071050 A1
(43) Pub. Date: Mar. 5, 2020

(54) ADHESIVE VALVE, SHEET, LAMINATED MATERIAL AND FOOD CONTAINER, AS WELL AS A PROCESS FOR MANUFACTURING THIS SHEET OR LAMINATED MATERIAL

(71) Applicant: Masterpack S.p.A., Monvalle VA (IT)

(72) Inventor: Valerio BINDA, Monvalle (VA) (IT)

(73) Assignee: Masterpack S.p.A., Monvalle VA (IT)

(21) Appl. No.: 16/493,165

(22) PCT Filed: Mar. 20, 2018
(86) PCT No.: PCT/IB2018/051845

§ 371 Date: Sep. 11, 2019

(30) Foreign Application Priority Data
Mar. 21, 2017 (IT) 102017000031043

(51) Int. Cl. B65D 77/22; B32B 3/26

(52) U.S. Cl. CPC B65D 77/225; B65D 77/2024; B32B 3/266

(57) ABSTRACT

An adhesive valve that includes a flexible label having an upper surface and a lower surface provided with adhesive is disclosed. The value includes a flexible membrane which is applied to the lower surface of the flexible label and has a substantially non-adhesive lower surface and can be adhesively joined to a further surface so that the flexible membrane is arranged between the flexible label and further surface. The flexible label has an incision that connects the two surfaces of the flexible label at the flexible membrane. An incision connects the two surfaces of the flexible membrane and is covered by the flexible label. The incision in the flexible membrane forms a tongue-shaped portion. The invention also relates to a sheet a laminated material and a food container containing the adhesive valve, as well as a process for manufacturing the laminated sheet or material.

### TECHNICAL FIELD

The present description concerns an adhesive valve, in particular an adhesive and flexible valve which can be applied on incisions or openings made in hermetic containers, for example for food to be heated, in order to release gases which develop therein. The present disclosure also relates to a sheet, a laminated material and a food container comprising said adhesive valve, as well as a process for manufacturing this laminated sheet or material.

### FRAMEWORK OF THE DESCRIPTION

European patent 2275252 describes an adhesive valve which comprises a flexible label having at least one lower surface provided with adhesive, wherein a flexible membrane is applied to the lower surface of the flexible label, is completely covered by the flexible label and has a lower surface substantially non-adhesive. To act as a gas relief valve, one or more incisions are made in the flexible label straddling the geometric projection of the perimeter of the flexible membrane. In this known adhesive valve the gas flow rate of the vent is greatly influenced by the type of adhesive used to fix the valve to the container, so if the adhesive is too strong it is difficult for the label to rise at the incisions, whereas if it is too weak there is the risk that the valve does not correctly exercise its closing function.

To solve this technical problem publication WO 2015/111015 A1 describes a similar adhesive valve, in which the flexible membrane is always completely covered by the flexible label but is provided with incisions which intersect with incisions made in the flexible label.

The adhesive valves known from these publications, however, have a not entirely optimal functioning, that is a gas release greater or less than expected according to the size and shape of the flexible label and the flexible membrane, when they are pulled or bent, in particular due to the swelling or bending of the sheet on which they are applied.

Furthermore, such adhesive valves can be damaged easily because they are arranged outside the container.

WO 2006/107974 A1 discloses an adhesive valve comprising a flexible membrane which is applied to the upper surface of a flexible label and is provided with one or more tongue-shaped incisions. The flexible label has an incision forming an opening which connects its two surfaces at the flexible membrane. Since the flexible membrane opens outwardly and is not covered by the flexible label, said known valve has a completely different structure and operation from the valves of EP 2275252 and WO 2015/111015 A1, so that it cannot guarantee adequate gas tightness and protection against external agents.

### SUMMARY OF THE DESCRIPTION

The object of the present description is therefore to provide an adhesive valve free from such drawbacks. Said object is achieved with an adhesive valve, a sheet, a process, a laminated material and a container, the main characteristics of which are specified in the claims.

Thanks to its particular structure, the adhesive valve according to the present description can be arranged inside a container, so as to improve the airtightness, the gas venting capacity and the relative inviolability of the valve itself, especially if the adhesive valve it is inserted into a laminated material. The dimensions of the adhesive valve can be reduced by up to 50% with the same performance as traditional adhesive valves, so as to reduce the amount of material and improve the appearance of the final product.

Thanks to its particular convex portion, a sheet comprising the adhesive valve has a cavity which can house the portion of the flexible membrane which rises due to the pressure inside the container, so as to improve the effectiveness of the adhesive valve.

If a portion of the flexible membrane is not covered by the flexible label, the functionality of the adhesive valve is less affected by the effects caused by its deformation, for example by traction or bending.

Thanks to the particular dimensions and shapes of the flexible label, the flexible membrane and/or the relevant incisions, the effects of the possible deformation of the adhesive valve on its functionality are further limited.

The sheet and the laminated material according to the present description can moreover be manufactured with a relatively simple, economical and fast procedure.

### BRIEF DESCRIPTION OF THE DRAWINGS

Further advantages and characteristics of the adhesive valve, the sheet, the container and the process according to the present description will be clear to those skilled in the art from the following detailed and non-limiting description of some embodiments thereof with reference to the attached drawings wherein:

FIG. 1 shows a top view of a first embodiment of the adhesive valve arranged on a support;

FIG. 2 shows a bottom view of the adhesive valve of FIG. 1 without the support;

FIG. 3 shows the enlarged section III-III of FIG. 2;

FIG. 4 shows a top view of a second embodiment of the adhesive valve;

FIG. 5 shows a bottom view of the adhesive valve of FIG. 4;

FIG. 6 shows a top view of a third embodiment of the adhesive valve;

FIG. 7 shows a bottom view of the adhesive valve of FIG. 6;

FIG. 8 shows a top view of a fourth embodiment of the adhesive valve;

FIG. 9 shows a bottom view of the adhesive valve of FIG. 8;

FIG. 10 shows a top view of the sheet comprising the first embodiment of the adhesive valve;

FIG. 11 shows a bottom view of the sheet of FIG. 10;

FIG. 12 shows the enlarged section XII-XII of FIG. 11;

FIG. 13 shows the sheet of FIG. 12 during use;

FIG. 14 shows a laminated material comprising the sheet of FIG. 12;

FIG. 15 shows a schematic view of the process for manufacturing the laminated material of FIG. 14.

### EXEMPLARY EMBODIMENTS

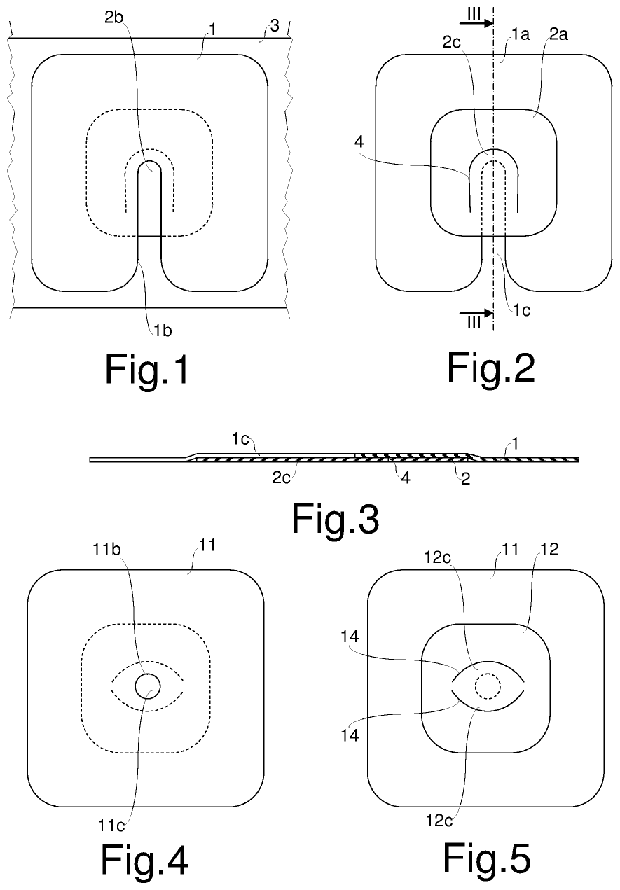

With reference to FIGS. 1 to 3, it is seen that the adhesive valve according to a first embodiment comprises, in a known manner, a flexible label 1 having at least one lower surface 1a provided with adhesive. At least one flexible membrane 2 is applied beneath the lower surface 1a of the flexible label 1 and in turn has a substantially non-adhesive lower surface 2a, i.e. that is not provided with adhesive or is substantially less adherent than the lower surface 1a of the label flexible 1 provided with adhesive. The flexible membrane 2 is preferably obtained by punching a support 3 of the same material, in sheet or strip, which has a larger extension than the flexible label 1 and on which one or more flexible labels 1 of the same type are applied, arranged on at least one row. Also the flexible label or labels 1 can be obtained by punching a sheet or a larger strip having a surface provided with adhesive, in which the exceeding part, i.e. the part not including the label or the labels 1, is removed after the application of the same on the support 3.

The flexible label 1 and the flexible membrane 2 may be obtained from a film of a plastic material suitable for coming into contact with food belonging in particular to the group consisting of polypropylene (for example, between 35 and 60 microns thick), polyester (for example, between 25 and 45 microns thick) or plastic materials with equivalent characteristics. The film of the flexible label 1 may be formed from a laminate of the same plastic materials and/or a polyamide film (for example, between 10 and 20 microns thick), or a PE-Evoh-PE laminate.

The lower surface 2a of the flexible membrane 2 is preferably treated with a material preferably compatible with a food use, which is suitable to make it non-adherent or limitedly adherent, in particular silicone or vaseline oil.

The adhesive layer applied to the lower surface 1a of the flexible label 1 may be a pressure-activated adhesive or PSA (Pressure Sensitive Adhesive), in particular an aqueous-based or UV cross-linking acrylic adhesive or an acrylic adhesive with an organic solvent, or a silicone-based adhesive for high temperatures (up to 250° C.).

Further characteristics of the materials and of the manufacturing process of the flexible label 1 and of the flexible membrane 2 are described in the European patent 2275252 and in the publication WO 2015/111015 A1.

The flexible label 1 may be shaped with a particular incision 1b such that at least one portion 2b of the upper surface of the flexible membrane 2 is not covered by the flexible label 1. In particular, at least one portion of the perimeter of the flexible label 1 passes above the flexible membrane 2, so that this portion of the perimeter divides the flexible membrane 2 in the portion 2b not covered by the flexible label 1 and in at least one remaining portion covered by the flexible label 1 (and delimited by a broken line in FIG. 1). The surface area of the flexible membrane 2 covered by the flexible label 1 is preferably larger than the area of the surface of the flexible membrane 2 not covered by the flexible label 1. The flexible label 1 has a substantially polygonal and/or curvilinear shape, for example square with rounded corners. The flexible label 1 preferably extends over an area wide x mm and long y mm, with x and y between 20 and 30, in particular 25. The flexible membrane 2 has a substantially polygonal and/or curvilinear shape, for example square with the rounded corners. The perimeter of the flexible label 1 preferably has at least one concave portion 1c which acts as an opening, starts from an outer edge of the flexible label 1 and extends towards the inside of the flexible label 1. The opening 1c preferably comprises the portion of the perimeter of the flexible label 1 passing over the flexible membrane 2. The opening 1c preferably has an elongated shape, in particular substantially rectangular with rounded corners, i.e. similar to a tongue.

The flexible membrane 2 comprises at least one incision 4 which connects the two surfaces of the flexible membrane 2 and is covered by the flexible label 1. The incision 4 preferably has an arched shape and in particular forms in the flexible membrane 2 a tongue-shaped portion 2c which can be separated from the flexible label 1 while keeping the remaining portion of the flexible membrane 2 joined to the flexible label 1. The incision 4 may at least partially surround the opening 1c of the flexible label 1. The incision 4 in the flexible membrane 2 does not cross the incision 1b in the flexible label 1.

With reference to FIGS. 4 and 5, it is seen that in a second embodiment the flexible label 11 does not comprise a concave portion as in the first embodiment, but instead comprises an opening 11c which is arranged above the flexible membrane 12 and is obtained by cutting, for example with a circular incision 11b, the flexible label 11 and removing the portion delimited by this incision. The flexible membrane 12 therefore comprises a portion not covered by the flexible label 11 which corresponds to the opening 11c. In an alternative embodiment, the portion of the flexible label 11 delimited by the incision 11b may also not be removed, so that only the incision 11b connects the two surfaces of the flexible label 11.

The flexible membrane 12 comprises in this embodiment two or more incisions 14 which are covered by the flexible label 11. The incisions 14 preferably have an arcuate shape and in particular form in the flexible membrane 12 two tongue-shaped portions 12c which can be separated from the flexible label 11 while keeping the remaining portion of the flexible membrane 12 joined to the flexible label 11. The incisions 14 may at least partially surround the opening 11c of the flexible label 11. The incisions 14 in the flexible membrane 12 do not cross the incision 11b in the flexible label 11.

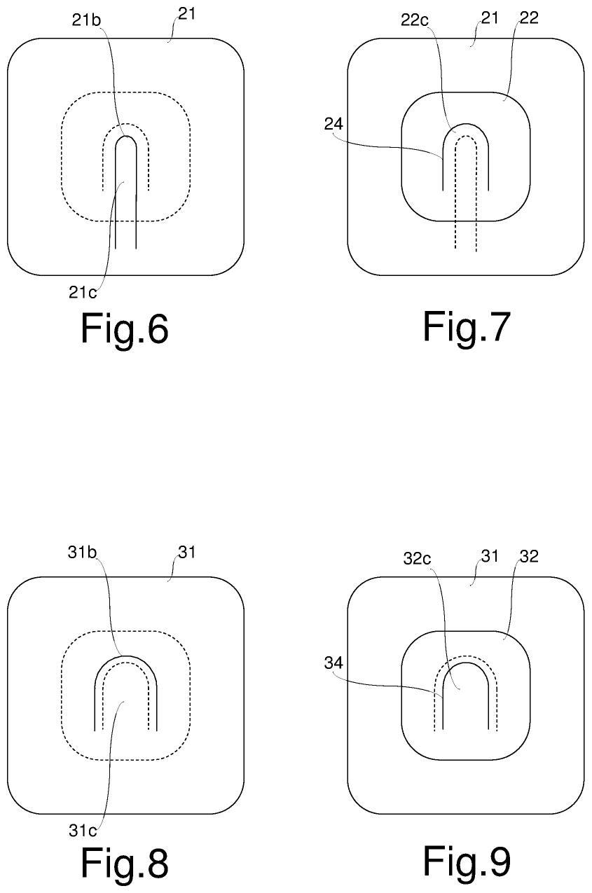

With reference to FIGS. 6 and 7, it is seen that in a third embodiment the flexible label 21 comprises only one incision 21b which is arranged at least partially above the flexible membrane 22 and which does not define an opening as in the first two embodiments.

The flexible membrane 22 comprises at least one incision 24 which is covered by the flexible label 21. The incision 24 in particular forms in the flexible membrane 22 a tongue-shaped portion 22c which can be separated from the flexible label 21 while keeping the remaining portion of the flexible membrane 22 joined connected to the flexible label 21. The incision 24 in the flexible membrane 22 can at least partially surround the incision 21b in the flexible label 21. The incision 21b in particular forms in the flexible label 21 a tongue-shaped portion 21c which can be separated from the flexible label 21 together with the tongue-shaped portion 22c of the flexible membrane 22. The incision 21b of the flexible label 21 may extend beyond the perimeter of the flexible membrane 22.

With reference to FIGS. 8 and 9, it is seen that in a fourth embodiment similar to the third embodiment, the flexible label 31 comprises at least one incision 31b which however is completely arranged above the flexible membrane 32.

The flexible membrane 32 comprises at least one incision 34 which is covered by the flexible label 31. The incision 34 in particular forms in the flexible membrane 32 a tongue-shaped portion 32c which can be separated from the flexible label 31 while keeping the remaining portion of the flexible membrane 32 joined to the flexible label 31. The incision 34 in the flexible membrane 32 is at least partially surrounded by the incision 31b in the flexible label 31. The incision 31b in particular forms in the flexible label 31 a tongue-shaped portion 31c which can be separated from the flexible label 31 together with the tongue-shaped portion 32c of the flexible membrane 32.

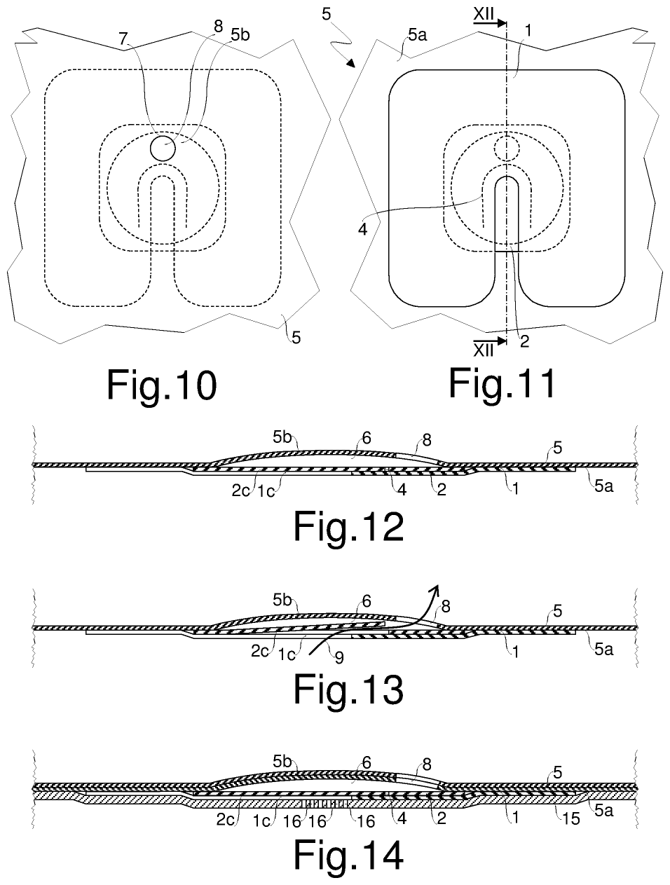

With reference to FIGS. 10 to 12, it is seen that the lower surface of the flexible label 1 can be joined to a surface 5a by means of the adhesive arranged between these surfaces, so that the flexible membrane 2 is arranged between the flexible label 1 and the surface 5a. The surface 5a is in particular the inner surface of a sheet 5 suitable for closing or forming a food container, for example a sheet of plastic material which can be used to make a bag or to be heat sealed to the edges of a rigid tray. Therefore, the flexible label 1 faces the inside of the container comprising the sheet 5. The sheet 5 preferably comprises at least one convex portion 5b facing outwards, namely facing the side opposite to the flexible label 1, so as to form a cavity 6 between the sheet 5 and the flexible membrane 2. The convex portion 5b has a shape of a spherical cap having a substantially circular extension preferably included in the perimeter of the flexible membrane 2. The diameter of the convex portion 5b is preferably comprised between 8 and 10 mm. At least one incision 7 is made in the convex portion 5b of the sheet 5, so as to connect the cavity 6 with the outside. The incision 7 in the sheet 5 may be closed, so that the portion of the sheet 5 surrounded by the incision 7 can be removed and form an opening 8. In an alternative embodiment the incision in the sheet 5 can be arched, in so as to form in the convex portion 5b a tongue-shaped portion which can bend outwards.

Referring to FIG. 13, it can be seen that if in the container comprising the sheet 5 a pressure substantially greater than the pressure outside the container itself is generated, for example caused by cooking food in the container, the gases 9 in the container lift in the cavity 6 the tongue-shaped portion 2c of the flexible membrane 2, overcoming the force of the adhesive of the flexible label 1, so that these gases 9 pass out of the container through the opening 1c of the flexible label 1, the tongue-shaped portion 2c of the flexible membrane 2 and the opening 8 in the sheet 5. When the pressure in the container returns to be substantially equal to the external pressure, the tongue-shaped portion 2c of the flexible membrane 2 can again adhere to the flexible label 1, in particular thanks to electrostatic forces and/or Van der Waals forces that are created between the flexible membrane 2 and the flexible label 1. To improve the separation of the tongue-shaped portion 2c of the flexible membrane 2 from the flexible label 1, the adhesive applied between the tongue 2c and the flexible label 1 may be applied in smaller quantities and/or exert a lower adhesion with respect to the adhesive applied around the tongue 2c.

FIG. 14 shows a further embodiment which consists of a laminated material in which the first sheet 5 is formed by an inner layer of metal, for example aluminum, coupled with an outer layer of plastic, for example polyester. Furthermore, a second sheet 15 preferably of plastic is applied inside, so that the flexible label 1 and the flexible membrane 2 are arranged between the first sheet 5 and the second sheet 15. The second sheet 15 has at least one incision, in particular a series of holes 16, at the opening 1c formed in the flexible label 1.

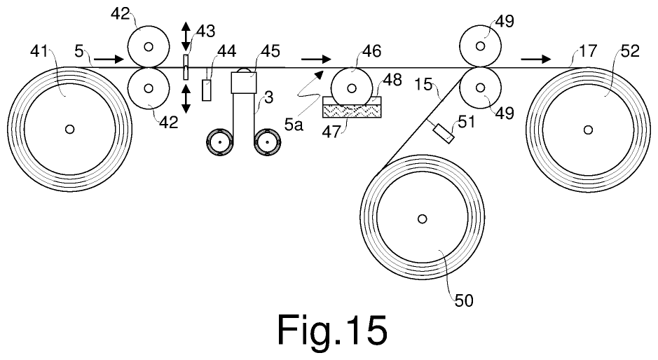

Referring to FIG. 15, it is seen that in a first operating step of the manufacturing process according to the present description the first sheet 5 preferably wound on a first roller 41 is pulled in the direction of the arrows by one or more first auxiliary rollers 42, after which a punching machine 43, in particular a hot punching machine, forms in the sheet 5 the convex portion 5b facing upwards. If the sheet 5 comprises a single layer, the punching machine 43 can also form in the sheet 5 the opening 8 thanks to a perforating tip placed on the punch, otherwise, if the sheet 5 comprises several layers, it is preferable that the opening 8 is formed in the sheet 5 by a perforator 44, in particular a laser perforator, arranged before or after the punching machine 43. A labeling machine 45 withdraws from the support 3 and applies at least one adhesive valve according to the present description at the convex portion 5b of the sheet 5, with the lower surface 1a of the flexible label 1 in contact with the lower surface 5a of the sheet 5. An applicator roller 46 applies on the lower surface 5a of the sheet 5 an layer of adhesive 47 taken from a tank 48. Second auxiliary rollers 49 pull and they join together, by means of the adhesive 47, the first sheet 5 and the second sheet 15, which is wound on a second roller 50. A perforator 51, for example a laser perforator, makes one or more incisions or openings 16 in the second sheet 15 before the latter is joined to the first sheet 5. The laminated material 17 comprising the sheets 5, 15, as well as one or more adhesive valves according to the present description, is wound on a third roller 52.

In a subsequent step, not shown in the figures, the laminated material 17 can be taken from the third roller 52 and cut to obtain a plurality of sheets which comprise at least one adhesive valve and can be used to make enclosures for food use, for example as a cover of a container in which the second sheet 15 is joined to the edge of this container, in particular by means of adhesive or heat-sealing, whereas the first sheet 5 faces outwards.

Any variations or additions may be made by those skilled in the art to the embodiments described and illustrated herein while remaining within the scope of the following claims. In particular, further embodiments may include the technical characteristics of one of the following claims with the addition of one or more technical characteristics described in the text or illustrated in the drawings, taken singularly or in any mutual combination.

1. Adhesive valve that comprises a flexible label having an upper surface and a lower surface which is provided with adhesive, wherein a flexible membrane is applied to the lower surface of the flexible label and has a substantially non-adhesive lower surface, wherein the lower surface of the flexible label is suitable to be joined to a further surface by means of said adhesive so that the flexible membrane is arranged between the flexible label and the further surface, wherein the flexible label has an incision that connects the two surfaces of the flexible label at the flexible membrane, wherein an incision connects the two surfaces of the flexible membrane and is covered by the flexible label, wherein the incision in the flexible membrane forms in the flexible membrane a tongue-shaped portion.

2. Adhesive valve according to claim 1, wherein the incision in the flexible membrane surrounds at least partially the incision in the flexible label.

3. Adhesive valve according to claim 1, wherein the incision in the flexible label extends beyond the perimeter of the flexible membrane.

4. Adhesive valve according to claim 1, wherein the incision in the flexible label forms in the flexible label a tongue-shaped portion at the tongue-shaped portion of the flexible membrane.

5. Adhesive valve according to, wherein the incision in the flexible label defines an opening in the flexible label, so that a portion of the flexible membrane is not covered by the flexible label.

6. Adhesive valve according to claim 1, wherein a portion of the perimeter of the flexible label passes over the flexible membrane, so that the portion of the perimeter divides the flexible membrane in a portion not covered by the flexible label and in a portion covered by the flexible label.

7. Adhesive valve according to claim 1, wherein the incision in the flexible membrane does not cross the incision in the flexible label.

8. Sheet comprising an incision, which comprises an adhesive valve according to claim 1, wherein the adhesive valve covers the incision.

9. Sheet according to claim 8, wherein said incision is formed in a convex portion of the sheet, which convex portion is arranged on the side opposite to the adhesive valve, so as to form a cavity between the sheet and the adhesive valve.

10. Process for manufacturing sheets, comprising: forming a convex portion comprising an incision in a first sheet;
applying an adhesive valve according to claim 1 to a surface of the first sheet, wherein the convex portion of the first sheet is arranged on the side opposite to the adhesive valve, so as to form a cavity between the first sheet and the adhesive valve.

11. Process according to claim 10, wherein the extension of the convex portion of the sheet is included in the perimeter of the flexible membrane of the adhesive valve.

12. Process according to claim 10, further comprising:
forming an incision in a second sheet;
coupling the first sheet with the second sheet, so that the adhesive valve is arranged between the first sheet and the second sheet, wherein said incision is arranged at the flexible label of the adhesive valve.

13. Process according to claim 12, wherein the first sheet is coupled with the second sheet by means of adhesive applied to one surface of the first sheet after the adhesive valve has been applied to the same surface.

14. Laminate material, comprising a first sheet according to claim 8 coupled with a second sheet so that the adhesive valve is arranged between the first sheet and the second sheet, wherein the second sheet has an incision at the incision in the flexible label of the adhesive valve.

15. Container for food, comprising an adhesive valve according to claim 1.

16. Container according to claim 15, wherein the flexible label of the adhesive valve is arranged towards the inside of the container and the flexible membrane of the adhesive valve is arranged towards the outside of the container.

17. Sheet according to claim 9, wherein the extension of the convex portion of the sheet is included in the perimeter of the flexible membrane of the adhesive valve.

18. Container for food, comprising a sheet according to claim 8.

19. Container according to claim 18, wherein the flexible label of the adhesive valve is arranged towards the inside of the container and the flexible membrane of the adhesive valve is arranged towards the outside of the container.
